(19) United States
(12) Patent Application Publication
(10) Pub. No.: US 2009/0079318 A1
(43) Pub. Date: Mar. 26, 2009

(54) Spark Plug

(76) Inventor: Hosny Ibrahim Sabry, Cairo (EG)

Correspondence Address: DAFFER MCDANIEL LLP, P.O. BOX 684908, AUSTIN, TX, 78768, US

(21) Appl. No.: 12/250,112

(22) Filed: Oct. 13, 2008

Related U.S. Application Data
(63) Continuation of application No. PCT/EG06/00016, filed on Apr. 20, 2006.

(51) Int. Cl. H01T 13/20

(52) U.S. Cl. 313/140; 313/141

(57) ABSTRACT

The improved spark plug of the present invention includes three parallel electrodes in the form of letter (T) of identical strips made of nickel alloys or iridium. The positive electrode lies in the middle between the negative electrodes, so that each negative electrode is welded to the threaded end of the plug body. All the electrodes are in vertical position, and in the same horizontal plane. The gap distance between the electrodes is the same as in the traditional spark plug. Finally, the great area of the opposite electrodes (32 mm²) with respect to conventional spark plugs contributes to stronger sparks and more consistent firing.

### PRIORITY CLAIM

The present application is a continuation of pending International Application No. PCT/EG2006/000016 filed Apr. 20, 2006.

### TECHNICAL FIELD

The invention relates to internal combination engines (except diesel engines).

### BACKGROUND

Spark plugs are used in most interior combustion engines, excluding diesel ones, to provoke sparks of high potential igniting the mixture of fuel and air inside the combustion chamber. FIG. 1 illustrates a conventional spark plug which comprises terminal 1, anti-flashover 2, cap 3, gas-tight 4, central electrode 5, attached gasket 6, axial tip 7, spark gap 8, earth electrode 9, axial metallic electrode 10, insulating manifold of the plug core 11, and sheath assembly 12.

The design techniques and materials used vary from one manufacturer to another, but the following description is fairly representative. Plug bodies are made of high quality steel and are zinc plated to avoid corrosion. The spark plug consists of, as in FIG. 1, an external metallic housing 3 inside which porcelain insulator 11 is mounted, having a metallic electrode 10 of the circuit adjusted on the axis of the insulator. The external housing comprises the other metallic terminal 9 of the circuit, the terminal being short joined with solder to the end of the threaded body and arching towards the axial tip. The threaded portion on the external housing has to conform to internationally agreed standards and close tolerances and it is also of close durability, enough to install the spark plug into a threaded aperture in the head of engine cylinder. Ranges of plugs with various thread configurations are produced. The plug insulators are made from a fired aluminum oxide (ceramic material), which is highly resistant to thermal and mechanical stress, and chemical attacks. The electrodes are most commonly made from nickel alloys, but precious metals are sometimes used. Within the two electrodes, there is a gap distance 8 ranging between 0.5-1.016 mm (0.020-0.040) inches. Gas tight seals 4 are required between the center electrode and the insulator, and between the insulator and the plug body. These seals are formed from aluminum oxide powder which when compressed becomes a rigid mass fitting the available space exactly. To keep pace with engine requirements, new construction techniques and materials are constantly being evaluated.

When the engine is running, a pulse of electrical energy at very high voltage is delivered to the terminal of the plug (or plugs in the case of multi-cylinder engines, via the distributor). At the correct moment, this causes a spark to jump the gap between the center electrode 10 and the earth electrode 9, the latter being earthed to the cylinder block. This spark provides the energy needed to ignite the compressed fuel-air mixture in the cylinder.

For optimum performance, the temperature of the core nose at the firing end of a spark plug should neither drop below about 400° C. (752° F.) at 30 mph (48 km/h) cruising, nor exceed about 850° C. (1562° F.) at maximum speed and load. Below 400° C., deposits of carbon and oil are likely to accumulate on the core nose. Carbon being electrically conductive can provide a short circuit path for the high voltage pulse and so weaken or eliminate the spark.

Core nose temperature of above 850° C. can cause excessive electrode erosion and, possibly, uncontrolled ignition of the fuel-air mixture in advance of the timed spark. This condition (called pre-ignition) can cause serious engine damage. As engine designs (and therefore combustion chamber temperatures) vary, it is necessary to produce many types of spark plugs to ensure that, as far as possible, plug operating temperatures can be kept within the optimum range in all applications.

The classification of plugs according to their relative ability to transfer heat from the tip of the core nose to the cooling system of an engine is termed the heat range. For the purpose of determining which grade of plug is best for a specific engine, the manufacturers run tests using spark plugs comprising thermocouples (sensitive elements to temperature) at the core nose tips; whilst, constantly monitoring the temperature of the different types at the integrative extent of the engine load and speed.

The spark plugs should be cleaned every 10,000 km via sand paper or spark plug cleaner so as to remove the accumulated deposits on the base of central electrode, followed by adjusting the gap distance between the two electrodes through the lateral electrode by slightly bending the ground electrode. It is preferable to alter the plugs every 20,000 km averting the possible troubles and guarantee the high quality of activating the engine. Unless the new spark plugs are of the definite type according to engine guidelines, the insulating material will be destroyed. It is worth mentioning that the plug is rapidly consumed when its usage in the engine is under high temperature for the speed combustion of its terminals. Therefore, applying spark plugs of incorrect heat range drives occurrence of engine problems, as well as, causing cracks in the insulators of the plugs as a result of negligence on installing it or adjusting the gap between the plug's terminals.

Spark plugs having three or four earth electrodes are recently available being more efficient than that of mono earthed electrode and having undoubtedly a prolong functional life.

The problem or deficiency of the previous art: (1) the electrodes of the traditional spark plug are to be cleaned for removing the hanging deposits every 10,000 km at most; (2) upon removing the deposits, the gap distance between the two electrodes is to re-adjusted for not causing cracks in the plug insulators; and (3) every 20,000 km, the plugs have to be replaced for ending its expiry period suffering from oxidation and corrosion of its electrodes.

### BRIEF DESCRIPTION OF THE DRAWINGS

FIG. 1 represents longitudinal section of a traditional spark plug having one short ground metallic electrode which is welded to the end of the threaded body and arching toward its axial tip.

FIG. 2 represents the elevation section of a three electrodes spark plug.

FIG. 3 represents a horizontal section of the spark plug in FIG. 2.

FIG. 4 represents the horizontal section of a two electrodes spark plug.

FIG. 5 represents the elevation section of the spark plug in FIG. 4.

FIG. 6 represents the elevation section of a three electrodes spark plug where the length of each negative electrode equals half that of the positive electrode.

FIG. 7 represents the horizontal section of the spark plug in FIG. 6.

FIG. 8 represents the elevation section of a three electrodes spark plug.

FIG. 9 represents the horizontal section of the spark plug in FIG. 8.

FIG. 10A represents the front view of a two parallel electrodes (T shaped) spark plug.

FIG. 10B represents the elevation section of a two parallel electrodes (T shaped) spark plug.

FIG. 11A represents the front view of a three parallel electrodes (T shaped) spark plug.

FIG. 11B represents the elevation section of a three parallel electrodes (T shaped) spark plug.

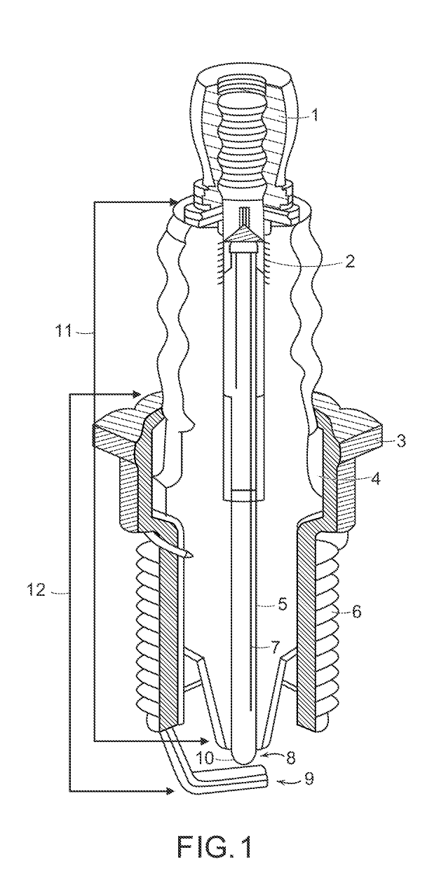

### DETAILED DESCRIPTION

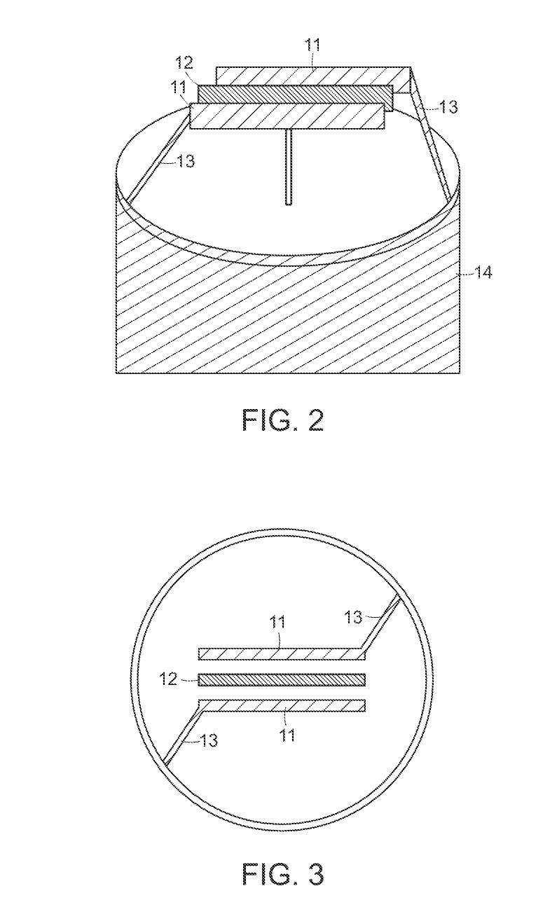

Spark plugs containing three electrodes (one positive electrode 12 in the middle and two negative electrodes 11 on its sides) are shown in FIGS. 2-3, 6-7, and 8-9. In all configurations, the positive electrode 12 is in the form of the letter T. The vertical part of the positive electrode 12 is an extension of the central axis of the spark plug and is elevated from 5 to 7 mm above the horizontal level of the threaded body end of the plug. The horizontal part of the positive electrode 12 is a thin metallic tape having a cuboid shape in a vertical position of 8 mm length, 2 mm width, and 1.5 mm thickness. The horizontal part is connected with the vertical part at its midpoint exactly. At both sides of the positive electrode 12, there are two negative electrodes 11, both in the shape of a rectangular metallic tape. In the configuration depicted in FIGS. 2 and 3, the negative electrodes 11 have a length of 8 mm, a width of 2 mm, and a thickness of 1.5 mm. In the configuration depicted in FIGS. 6 and 7, the negative electrodes have a length of 4 mm, a width of 2 mm, and a thickness of 1.5 mm. . In any case, the negative electrodes 11 are in a vertical position exactly parallel to the positive electrode 12, each supported by one mounting post 13 welded to the end of a threaded body 14 of the plug. Between the different electrodes 11, the spark gap should be kept as that of the traditional plugs (0.5-1.016 mm). All the electrodes are at the same horizontal level and are made of nickel alloys. The opposing faces of the electrodes (four electrode faces) must be electroplated with an antirust layer such as nickel chromium, platinum, or iridium alloys.

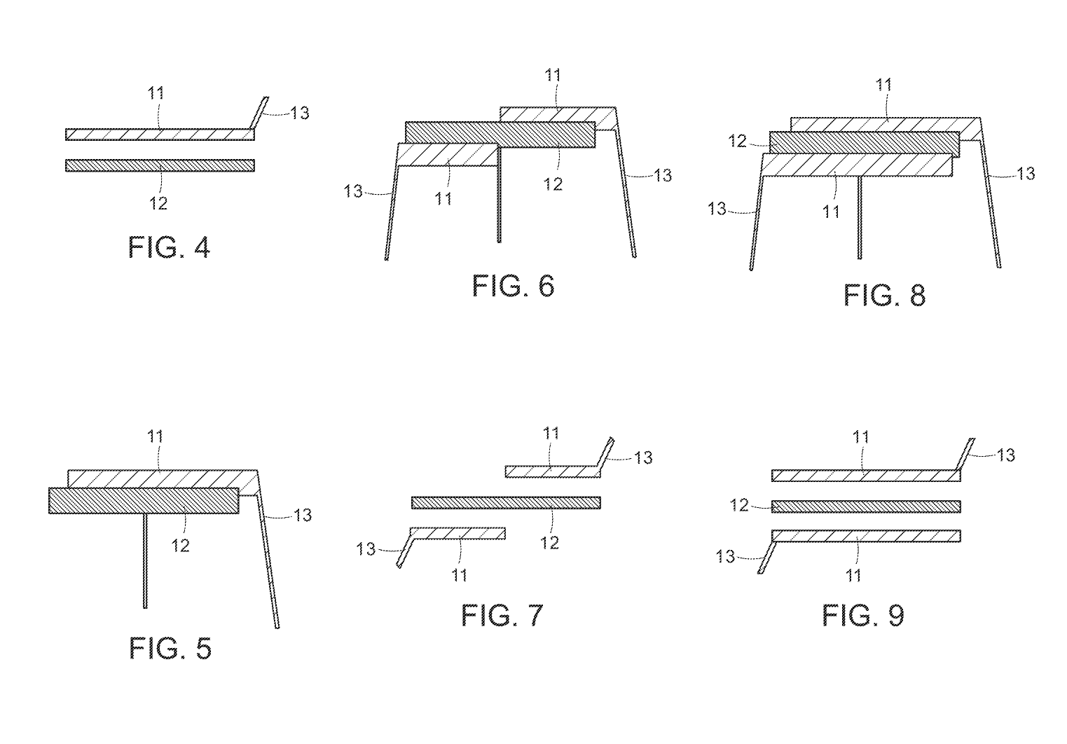

As shown in FIGS. 4 and 5, a spark plug may have two electrodes only, one positive electrode 12 in the form of a letter T and the other negative electrode 11, identical and parallel to it and at its same level. Similar to the configurations shown in FIGS. 2, 3, and 6-9, the negative electrode 11 in FIGS. 4 and 5 is supported by a mounting post 13.

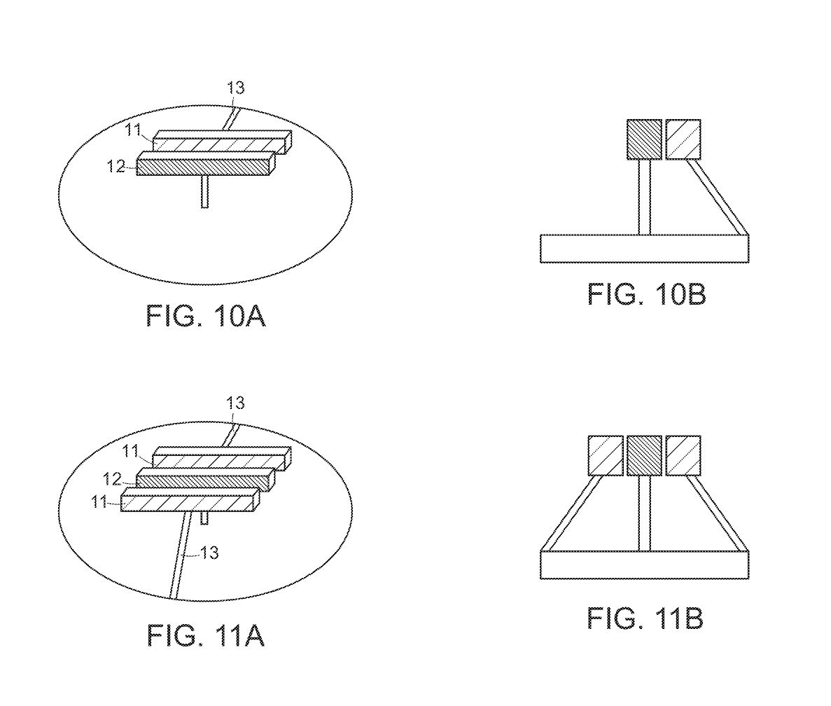

Finally, it is better to change the negative electrodes 11 so that they are identical to the positive electrode 12 in the form of a letter T letter also as shown in FIGS. 10 and 11.

The relevant design is characterized with the fact that the spark does not always jump between two electrodes in a certain direction as in the traditional plugs. Rather, it emits in any direction from the positive electrode to the corresponding point on a ground electrode. The platinum coating substantially facilitates the process by which sparks jump. As the area of any two opposite faces is 16 mm², the number of the corresponding points between the two different electrodes are so many that their oxidation takes a very long time compared to that in a traditional spark plug. If we assumed that after a long period of use, oxidation has occurred on the surfaces of two electrodes and deposits accumulated on them to impede the spark occurrence therebetween, this won't prevent the sparks from jumping between any other opposite and corresponding points on the other electrode (note that the plug has four opposing electrode surfaces each of area 16 mm² also), where their oxidation will take a long time also. This results in continuing the spark plug performance very efficiently and constantly for long periods of time.

Accordingly, the advantages and features of the invention may become apparent, for example: (1) the electrodes are situated such that they face each other with a gap therebetween. This provides a greater spark area (i.e., 32 mm²) compared to a conventional spark plug, providing more consistent and stronger sparks and even multiple sparks; (2) the aerodynamic flow of fuel in the gap results in more complete fuel burning in the combustion chamber for better fuel economy and increased power/acceleration; (3) the gap is set permanently at the time of manufacture, thereby eliminating problems with setting and maintaining the gap; and (4) from the environmental point of view it acts to minimize waste (consumed spark plugs), minimize gas emission from car exhausts, and saves money, raw materials, and energy consumed in manufacturing new plugs.

The advantage of this new design is that the gap distance is always fixed between the different electrodes. Any expansion, either linear or superficial, which occurs simultaneously to the electrodes during heating will not affect the gap distance at all.

Another advantage is that the surface areas of the positive electrodes equal 32 mm² (on both sides). This area is unknown in the majority of the spark plugs all over the world to date. This also provides a greater region of ignition and contributes to more consistent firing and prolongs the estimated life of the spark plug.

Finally, as the gap distance is not amendable, the gap distance must be written on the body of each spark plug, e.g. 0.5 mm or 0.7 mm, to enable the buyer to select the suitable spark plug for his car.

The modified spark plug does not require improving in the manufactured substance of the electrodes, or modifying the manufacturing machines of the spark plug. Its costs will be higher than that of the traditional one due to the increase in the material used in the ground electrode only or in both electrodes; however, this slight increase in price is compensated by advantages such as:

(1) The lifetime of the modified spark plug is relatively longer than that of a traditional one. To clarify, the spark area of a traditional spark plug is approximately 3.14 mm². The spark area of the modified spark plug disclosed herein is approximately 32 mm² or 10 times the area of the connecting electrodes from that of a traditional spark plug. The traditional spark plug has a service life of approximately 20,000 km; the modified spark plug described herein can operate for approximately 200,000 km or longer if the electrodes are manufactured of iridium, for example. Thus, the performance of the modified spark plug exceeds that of the traditional spark plug currently in the marketplace.

(2) It surpasses the other traditional types simply because the performance of an individual plug is dispensing to that of several plugs.

(3) Saving money and time wasted in purchasing new spark plugs and installing them periodically in the engines. In addition, there is no need to adjust the gap distance between the two electrodes after the cleaning process each time in the modified spark plug saving time and effort. (4) It does not need maintenance as in the traditional spark plug (every 10,000 km). “Maintenance” here means removing deposits that are stuck in its electrodes.

According to all these merits, the modified spark plug will be out of competition and preferred to consumers.

1. A spark plug comprising a central positive electrode in a shape of a capital letter T, wherein a vertical portion of the positive electrode is aligned with a central axis of the spark plug, and wherein a horizontal part of the positive electrode is a metallic tape of nickel or iridium alloys arranged in a vertical position.

2. The spark plug of claim 1, further comprising:
two negative electrodes, wherein the positive electrode lies exactly at the middle between the two negative electrodes, wherein each of the two negative electrodes is a metallic tape of nickel or iridium alloys, and wherein the two negative electrodes are completely parallel to the horizontal part of the positive electrode; and
two metallic rods respectively connecting ends of the two negative electrodes to a threaded body of the plug.

3. The spark plug of claim 2, wherein distances between the horizontal part of the positive electrode and each of the two negative electrodes are between 0.5-1.016 mm.

4. The spark plug of claim 2, wherein the two negative electrodes are of identical dimensions with the horizontal part of the positive electrode.

5. The spark plug of claim 2, wherein the two negative electrodes each comprise a smaller dimension than the horizontal part of the positive electrode.

6. The spark plug of claim 2, wherein the two negative electrodes are at the same horizontal level as the horizontal part of the positive electrode.

7. The spark plug of claim 2, wherein the two negative electrodes are in the shape of the capital letter T.

8. The spark plug of claim 7, wherein the two negative electrodes are of identical dimensions with the positive electrode.

9. The spark plug of claim 1, further comprising:
a single negative electrode, wherein the single negative electrode is a metallic tape of nickel or iridium alloys, and wherein the single negative electrode is completely parallel to the horizontal part of the positive electrode; and
a metallic rod connecting the single negative electrode to a threaded body of the plug.

10. The spark plug of claim 9, wherein the single negative electrode is at the same horizontal level as the horizontal part of the positive electrode.

11. The spark plug of claim 9, wherein the single negative electrode is in the shape of the capital letter T.

12. The spark plug of claim 11, wherein the single negative electrode is of identical dimensions with the positive electrode.
